(19) United States
(12) Patent Application Publication
(10) Pub. No.: US 2014/0216269 A1
(43) Pub. Date: Aug. 7, 2014

(54) Cooking Device with Separate Compartments

(71) Applicant: Erik B. Cooley, Layton, UT (US)

(72) Inventor: Erik B. Cooley, Layton, UT (US)

(21) Appl. No.: 13/762,190

(22) Filed: Feb. 7, 2013

(51) Int. Cl. A47J 37/04

(52) U.S. Cl. CPC A47J 37/041
USPC 99/377

(57) ABSTRACT

A cooking device comprises a bottom pan comprising a plurality of bottom compartments being configured to separately contain food items during a cooking process. A top pan covers the bottom compartments to separately retain the food items. A hinge mechanism enables the top pan and the bottom pan to swing apart. A clasp mechanism retains the top pan to the bottom pan in a closed position. A handle is joined to the bottom pan for placing the retained top pan and the bottom pan on a heat source. The handle comprises a length sufficient to enable the user to maintain a safe distance from the heat source during the cooking process, and to enable the user to flip over the retained top pan and the bottom pan in which the food items remain separated.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to cooking utensils. More particularly, one or more embodiments of the invention relate to a device for cooking multiple food items at once that may be used with an outdoor cooking source such as, but not limited to, a barbeque or campfire.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Cooking some items in an outdoor setting such as, but not limited to over a fire or on a barbeque can be challenging. For example, without limitation, one may expect that cooking over a fire may result in uneven cooking of the items, the need to turn the food often, and the risk of burning the food or the person cooking. Furthermore, it is believed that foods cooked openly over a fire but not in a closed container, for, example, without limitation, on a hot dog stick, usually have a smoky taste. While this may be desirable with certain foods including, without limitation, meat it is typically not desirable with breads and similar foods. In addition, when cooking on a hotdog on marshmallow stick, items may fall from the stick and only a small number of items (e.g., one or two) may be cooked at one time. Additionally injury may result from the heat of the fire or from the heat of the cooking utensil that is being used. As a non-limiting example, often when cooking a hamburger, a hot dog, or a steak over a barbeque, the barbeque is so hot that the user may need to protect his hand from the heat even during the short time spent turning the meat. This same situation may also exist with a campfire, and the heat exposure may be increased since the hands, face, clothing, or almost any part of the body may be burned.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that there are currently known devices that are designed with longer handles to allow for cooking over an open fire or barbeque including, without limitation, sandwich makers and hotdog or marshmallow sticks. However, these devices usually only comprise one or two cooking compartments, and at most three compartments or they have no compartments at all. Large cooking devices with single compartments such as, but not limited to, Dutch ovens may also be used for cooking over an open fire. However, if multiple types of food are cooked in this compartment, the food tastes often co-mingle together even when such co-mingling is not intended or desired. It is true that multi-compartment pans exist for cooking both similar and different types of food simultaneously. However, these cooking devices are typically not designed to cook over an open fire or on a barbeque type device. These devices are generally designed to be used on a household stove where only a short handle is typically needed or in an oven where no handle is typically needed. For example, without limitation, some of these devices such as, but not limited to, a Danish aebleskiver pan, may have short handles that may become dangerously hot when cooking over an outdoor heat source like a campfire or barbeque, which may result in injury. Other devices including, without limitation, cupcake or muffin pans that have no handle may be placed into the coals of a fire, onto the grill of a barbeque device, or positioned on a grill over the fire with food inserted into the cavities of the pan. A person using this type of device may need to constantly turn the food over and over until the food is fully cooked. Insufficiency of attention and turning of the food may result in uneven cooking of the food. Furthermore, the risk of burning the food or the person cooking the food can be much greater. One prior art device shows a pan designed for cooking and shaping bread rolls when the heat source is an oven. It includes a multiple compartment cooking utensil with a lid that is attached to a pan by hinges. It also includes a latch for the lid that serves the function of holding the lid in the closed position during cooking. It is designed to be used in an oven. This device however, does not include a long handle that would allow it to be used over a heat source like a campfire where it could be turned over and over to facilitate the cooking process, reduce the risk of burning the food, and reduce the risk of burning the user.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A through 1C illustrate an exemplary cooking device with multiple compartments, in accordance with an embodiment of the present invention. FIG. 1A is a side perspective view of the cooking device in a closed position with an extended handle. FIG. 1B is a side perspective view of the cooking device with the extensible handle in a retracted position. FIG. 1C is a side elevation view of the cooking device in a closed position with the handle retracted;

FIGS. 2A through 2F illustrate an exemplary pan section of a cooking device, in accordance with an embodiment of the present invention. FIG. 2A is a diagrammatic top view of the pan section of the device in a closed position. FIG. 2B is a diagrammatic bottom view of the pan portion in the closed position. FIG. 2C is side perspective view of the pan section of the device showing a clasp in an open position. FIG. 2D is a side perspective view of the pan section of the device showing the clasp in a closed position. FIG. 2E is a top perspective view of cooking pans extended in an open position and ready to receive food. FIG. 2F is a side perspective view of hinge mechanisms;

FIGS. 3A and 3B illustrate exemplary cooking compartments from a cooking device, in accordance with an embodiment of the present invention. FIG. 3A is a transparent side perspective view of a bottom compartment, and FIG. 3B is a transparent side perspective view of a top compartment in a closed position on the bottom compartment;

FIG. 4 is an exploded cross sectional view of an exemplary locking mechanism for an extensible handle of a cooking device in an extended position, in accordance with an embodiment of the present invention;

FIG. 5 a diagrammatic top view of an exemplary cooking device with 24 cooking compartments, in accordance with an embodiment of the present invention;

FIGS. 6A and 6B illustrate an exemplary cooking device with 60 cooking compartments, in accordance with an embodiment of the present invention. FIG. 6A is a diagrammatic top view, and FIG. 6B is a diagrammatic side view;

FIGS. 7A and 7B illustrate an exemplary cooking device with larger compartments, in accordance with an embodiment of the present invention. FIG. 7A is a diagrammatic top view, and FIG. 7B is a diagrammatic side view;

FIGS. 8A and 8B illustrate an exemplary cooking device with shallow compartments, in accordance with an embodiment of the present invention. FIG. 8A is a diagrammatic top view, and FIG. 8B is a diagrammatic side view;

FIG. 9 is a perspective bottom view of an exemplary cooking device, in accordance with an embodiment of the present invention; and

FIG. 10 is a flowchart illustrating an exemplary process for cooking a dough-based camping dessert over a campfire using a cooking device with multiple compartments, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art, many careful considerations and compromises typically must be made when designing for the optimal manufacture of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An embodiment of the present invention relates to a cooking utensil, which may enable users to cook a plurality of different food types, or multiple food items of the same food type, in a single multi-compartmentalized cooking device. Some embodiments may also comprise an extensible handle, which may aid in using the device for cooking food outdoors over a campfire, camp stove, barbeque type heat source, etc. Some embodiments may also comprise an attached and hinged lid and a lid latch. The multiple compartments in some embodiments may enable users to separately yet simultaneously cook multiple servings of the same type of food or multiple servings of different types of food, each in their own cooking compartment typically without an intermixing of the foods or flavors. Some embodiments may be implemented with as few as two cooking compartments or as many as sixty or more.

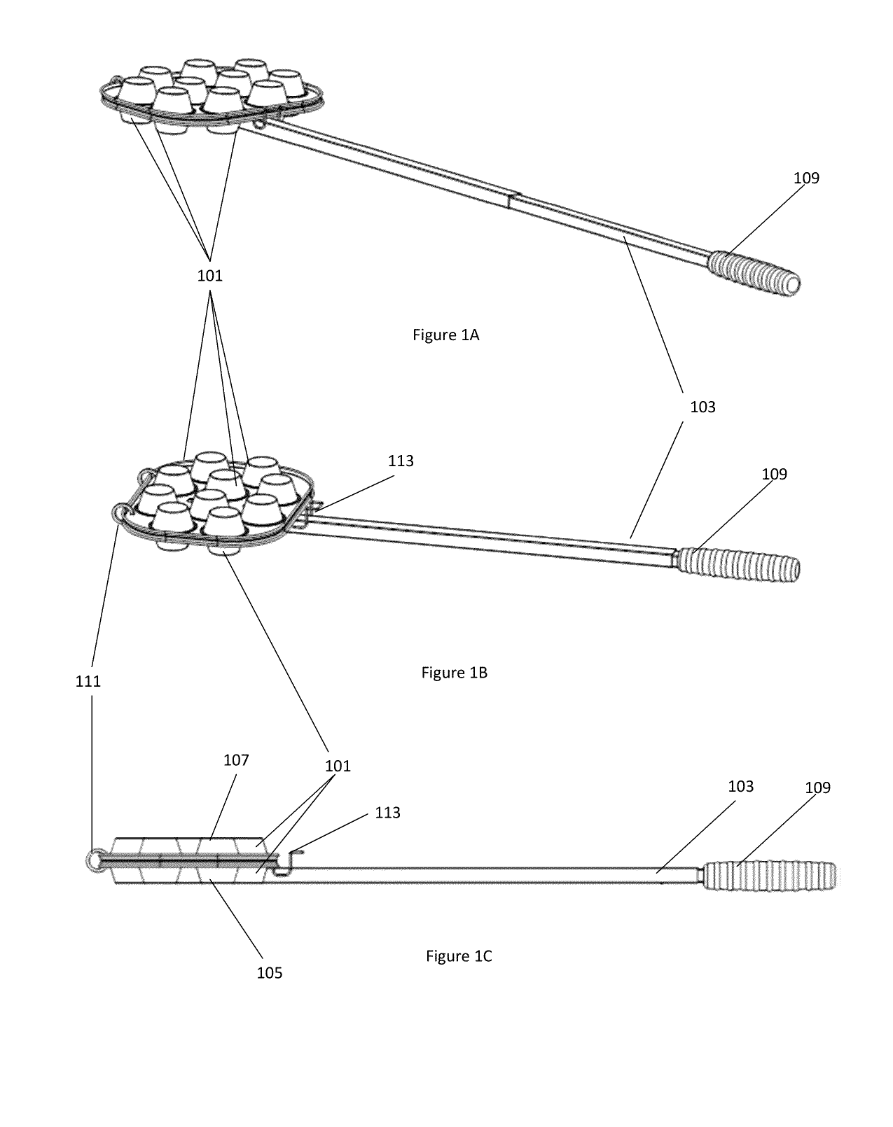

FIGS. 1A through 1C illustrate an exemplary cooking device with multiple compartments 101, in accordance with an embodiment of the present invention. FIG. 1A is a side perspective view of the cooking device in a closed position with an extended handle 103. FIG. 1B is a side perspective view of the cooking device with extensible handle 103 in a retracted position. FIG. 1C is a side elevation view of the cooking device in a closed position with handle 103 retracted. In the present embodiment, referring to FIG. 1C, the cooking device comprises a rectangular lower cooking pan 105 having rounded corners and an upper cooking pan 107 with similar dimensions to lower pan 105. The interior sections of lower pan 105 and upper pan 107 each comprise ten concave compartments 101, with each compartment 101 being approximately equal in dimension to every other compartment 101. Compartments 101 are substantially circular in outline with curved interior walls adjoining a flat bottom and one open end. Pans 105 and 107 are designed to be placed one on top of the other in an opposed position such that compartments 101 are aligned with each other, thereby creating cooking compartments 101 that are closed on all sides. In this respect, each of compartments 101 is designed to hold a quantity of food to be cooked. As such, all or only some of compartments 101 may be concurrently used to cook different foods without an intermixing of the foods or food flavors, thereby protecting flavor integrity of the food within each compartment 101. Additionally, all or some of compartments 101 may be concurrently used to cook separate servings of the same foods, thereby creating individual and separate portions. Moreover, the inclusion, without limitation, of bottom pan 105 and top pan 107, which are almost identical and work together in opposing positions, typically enables the device to be rotated, or turned over and over again, thereby cooking the food on both sides without the need to flip or rotate the food itself within the cooking device and also aids in shaping the food during cooking. Many other currently available multi-compartment cooking devices do not have lids that would allow this. Furthermore, the existing devices that have lids often do not have long handles or do not have multiple cooking compartments.

Referring to FIG. 1C, extensible handle 103 is permanently attached to bottom pan 105. Referring to FIG. 1A, handle 103 is shown in the extended position, and referring to FIGS. 1B and 1C, handle 103 is shown in the retracted position. Handle 103 may be extended to almost double the length of handle 103 in the retracted position so that one model of cooking device may be used for multiple heat sources. For example, without limitation, in the extended position handle 103 is approximately 32 to 38 inches long so the device can be easily used over a campfire typically with limited risk to the user of being burned. With handle 103 extended, the device may still be used over a more controllable heat source such as, but not limited to a barbeque type device or camp stove. A longer handle may become cumbersome in certain close-quarter cooking situations. For this reason, among others, handle 103 may be retracted for use over these types of heat sources. In the retracted position, handle 103 is approximately 14 to 18 inches long. Handle 103 also typically enables the device to be turned over and over again, to cook both sides of the food, without the need to touch the food. It is contemplated that some alternate embodiments may be made with a longer or shorter handle, handles that retract to various different lengths, or a non-extendable handle. For example, without limitation, some embodiments may comprise medium length handles that are approximately 10 to 20 inches in length. In embodiments with non-extendable handles, multiple models of the device may be provided including, without limitation, some models with long handles and other models with shorter handles. Other embodiments may be implemented with handles of various different shapes such as, but not limited to, curved handles. Different materials may also be used for the handle portion of the device, such as, but not limited to, solid aluminum rod, carbon steel rod, carbon steel tubing, aluminum tubing, etc. In some embodiments, a broom handle may be attached to the cooking device. In the present embodiment, handle 103 is also equipped with a grip portion 109 located at the opposite end of handle 103 from pans 105 and 107. This grip portion may not be included in some embodiments.

Referring to FIGS. 1B and 1C, in the present embodiment, the device comprises two hinge mechanisms 111, which facilitate the movement of upper pan 107 into a position directly opposed to lower pan 105 in a manner to create tight alignments such that compartments 101 on lower pan 105 and compartments 101 on upper pan 107 align accurately, thereby forming complete food cooking compartments. Hinge mechanisms 111 typically enable upper pan 107 to remain connected to lower pan 105 yet still open, similar to opening the lid on a jewelry box or opening a book. As upper pan 107 is lifted up into the open position, the cooking compartments 101 are revealed such that food can be added in preparation for cooking. Those skilled in the art will readily recognize, in light of and in accordance with the teachings of the present invention, that a multiplicity of suitable types of movable connection means may be used in some alternate embodiments such as, but not limited to, a small cabinet hinge, a jewelry box hinge, butterfly hinges, piano hinges, barrel hinges, spring mechanisms, chains, cables, etc. Other embodiments may include a hinge mechanism and the two pans snap or attach together during cooking but may be separated completely from each other for loading food into the compartments or for cleaning. Referring to FIGS. 1B and 1C, in the present embodiment, the device also comprises a clasp 113 or latching mechanism, on the opposite side of pans 105 and 107 from hinges 111, for generally maintaining the device in the closed position during the cooking process. Clasp 113 is shown in an open position in these figures.

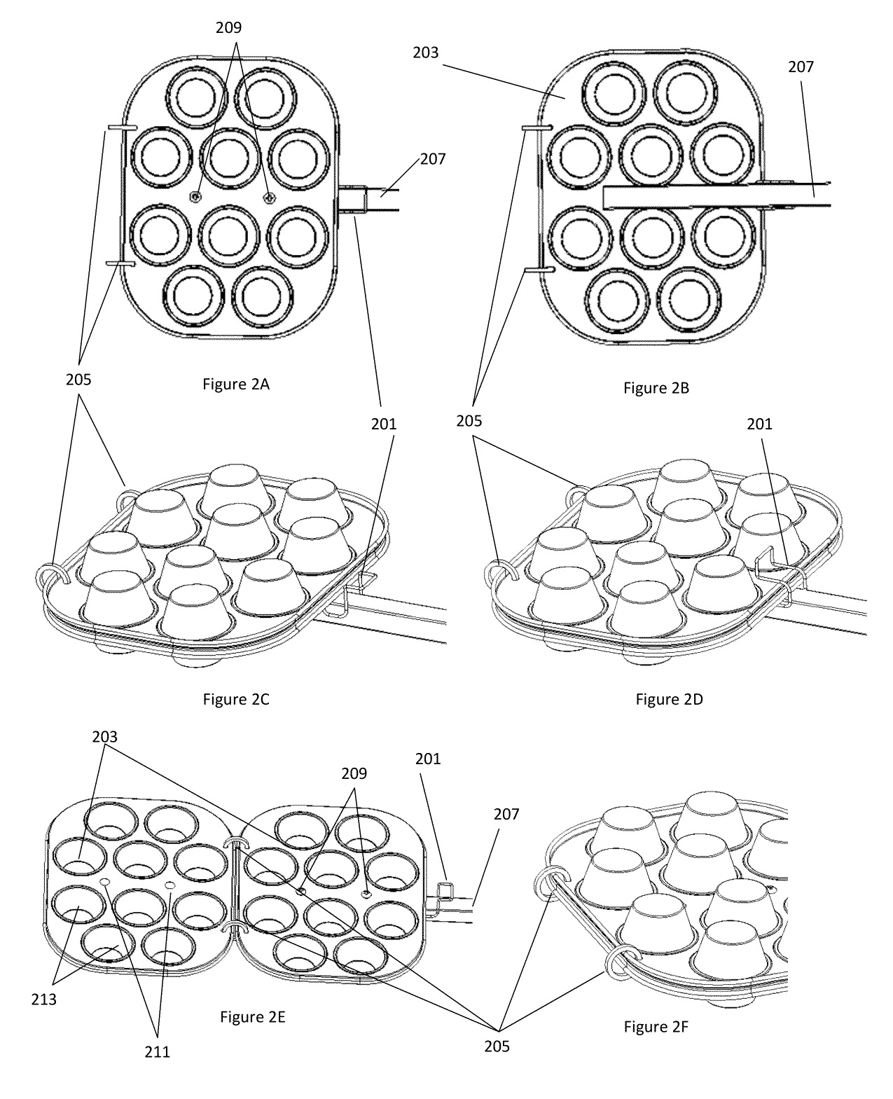

FIGS. 2A through 2F illustrate an exemplary pan section of a cooking device, in accordance with an embodiment of the present invention. FIG. 2A is a diagrammatic top view of the pan section of the device in a closed position. FIG. 2B is a diagrammatic bottom view of the pan portion in the closed position. FIG. 2C is a side perspective view of the pan section of the device showing a clasp 201 in an open position. FIG. 2D is a side perspective view of the pan section of the device showing clasp 201 in a closed position. FIG. 2E is a top perspective view of cooking pans 203 extended in an open position and ready to receive food. FIG. 2F is a side perspective view of hinge mechanisms 205. Referring to FIGS. 2A, 2B, and 2E, in the present embodiment, a handle 207 is attached to a pan 203 with screws 209. Holes 211 or indentations may be included, without limitation, on opposite pan 203 into which screws 209 can fit so that pans 203 may close together tightly. These holes or indentations may not be included in some embodiments. It is contemplated that the handles in some alternate embodiments may be attached using various different means such as, but not limited to, welding, rivets, or bolts. Handle 207 is attached to bottom pan 203 such that hinge mechanisms 205 are able to function and top pan 203 may be moved into the open position. Additionally, handle 207 is typically positioned in such a way that clasp 201 may be engaged and disengaged as desired. In some embodiments, the handle may be removable or foldable for storage or transport. In the present embodiment, clasp 201 is made of tempered steel wire to generally enable clasp 201 to hold its shape. Clasp 201 is attached to the same pan 203 as handle 207 on the opposite side of pan 203 from the hinge mechanisms 205, thereby holding pans 203 in the closed position during the cooking process. Clasp 201 can pivot from the attachment point and swing up into position over the edge of top pan 203, thereby holding pans 203 securely in place against one another until such time that a user repositions clasp 201 into the open position. Those skilled in the art will readily recognize, in light of and in accordance with the teachings of the present invention, that the clasps in some alternate embodiments may be made of various different materials such as, but not limited to different metals and various different types of clasps may be used including, without limitation, a locking pin, clamps, a cotter key that would slide into holes in the pan to hold the present invention closed, or if by removing the cotter pin would allow the present invention to be opened, when used in combination with the other design elements of hinges, etc. In some embodiments clasps may be located in various different places on the device and in some instances multiple clasps may be used. Some embodiments may be implemented with a closure system that typically enables users to open the closure without getting close to the pan portion of the device, which may be hot. One such embodiment comprises a clip that attaches to a pan and is controlled by a tempered wire that runs up the handle toward the user. The user may slide the wire device back and forth along the handle to lock or unlock the device.

Referring to FIG. 2E, pans 203 are shown extended in the open position and ready to receive food. This view illustrates by way of example the open regions of compartments 213 and a different view of hinges 205. In the present embodiment, hinges 205 are wire hinges that pass through hinge holes in each of pans 203. The two ends of hinges 205 are then connected together in a manner such as, but not limited to, spot welding so that hinges 205 generally do not separate from pans 203 or allow pans 203 to separate. In some alternate embodiments, hinge mechanisms may be used where hinge ends may not be connected. Hinges 205 are constructed of tempered wire and formed to be substantially circular in outline, similar to a lock washer or a hog ring type device. Hinge mechanism 205 secures the top and bottom pans 203 together and typically enables the top pan 203 to swing away from the bottom pan 203 into an open position much like a book would open. This feature generally allows food compartments 213 to be easily loaded with food for cooking. After loading the food into bottom pan 203, top pan 203 may then be moved into the closed position. Hinge mechanism 205 typically allows alignment such that top pan 203 falls correctly into position directly opposing and aligned with bottom pan 203. Once pans 203 are in the closed position, clasp 201 may be engaged to hold pans 203 in the closed position during the cooking process. It is contemplated that a multiplicity of suitable materials may be used for pans 203 such as, but not limited to, aluminum, carbon steel, stainless steel, cast iron, etc. Furthermore, pans 203 may be coated with Teflon® or other similar food grade non-stick type cooking coating such as, but not limited to, Silverstone®. This can free the user from needing to spray the device with non-stick cooking spray or coat the device with cooking oil or grease before each use. Some embodiments may not have a non-stick coating.

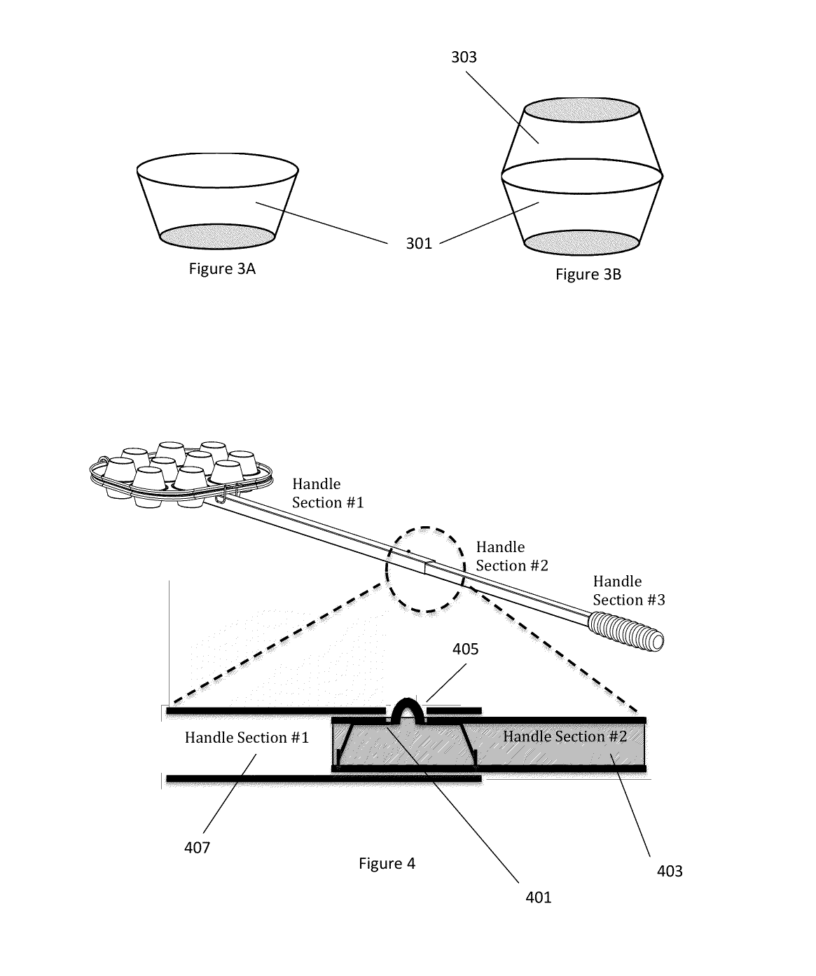

FIGS. 3A and 3B illustrate exemplary cooking compartments from a cooking device, in accordance with an embodiment of the present invention. FIG. 3A is a transparent side perspective view of a bottom compartment 301, and FIG. 3B is a transparent side perspective view of a top compartment 303 in a closed position on bottom compartment 301. In the present embodiment, compartments 301 and 303 are largely identical and substantially circular in outline with curved interior walls adjoining a flat bottom. Referring to FIG. 3A, bottom compartment 301 is shown in the open position and ready to receive food. Referring to FIG. 3B, bottom compartment 301 and top compartment 303 are shown in opposing positions and aligned to form a closed cooking compartment.

FIG. 4 is an exploded cross sectional view of an exemplary locking mechanism for an extensible handle of a cooking device in an extended position, in accordance with an embodiment of the present invention. In the present embodiment, the locking mechanism comprises a small wire device 401 that is permanently fit into an inner bar 403 of the handle. An inner bar 403 of the handle is able to slide into and out of an outer bar 407. A portion of wire device 401 fits into holes 405 in outer bar 407. Wire device 401 is spring loaded and a portion of wire device 401 protrudes through a hole in inner bar 403 in such a way that wire device 401 presses against outer bar 407. As bars 403 and 407 are extended or retracted, wire device 401 comes into alignment with holes 405 in outer bar 407. When wire device 401 slips into a hole 405 of outer bar 407, bars 403 and 407 are held in that position until a user determines to change the position of the handle. When a user determines to retract the handle, he may put pressure on the handle in a manner that would cause the handle to retract. As this pressure is applied, wire device 401 gives way and allows bars 403 and 407 to slide against each other to the next desired position. In the same manner, to extend the handle, the user simply pulls on the handle in a manner that would pull bars 403 and 407 away from each other. One or both bars 403 and 407 may comprise multiple holes, and as the holes on bar(s) 403 and 407 slide into alignment with each other, wire device 401 snaps into place within the holes thereby holding bars 403 and 407 in the chosen position. In some alternate embodiments various different means may be used to hold the extensible handle in place such as, but not limited to, friction, a spring-loaded button, a set screw or pin, threaded couplings, folding portions, etc. Furthermore, various different types of extending mechanisms may be used in some alternate embodiments including, without limitation, folding handles, other types of telescoping handles, screw together handles, snap together handles, etc.

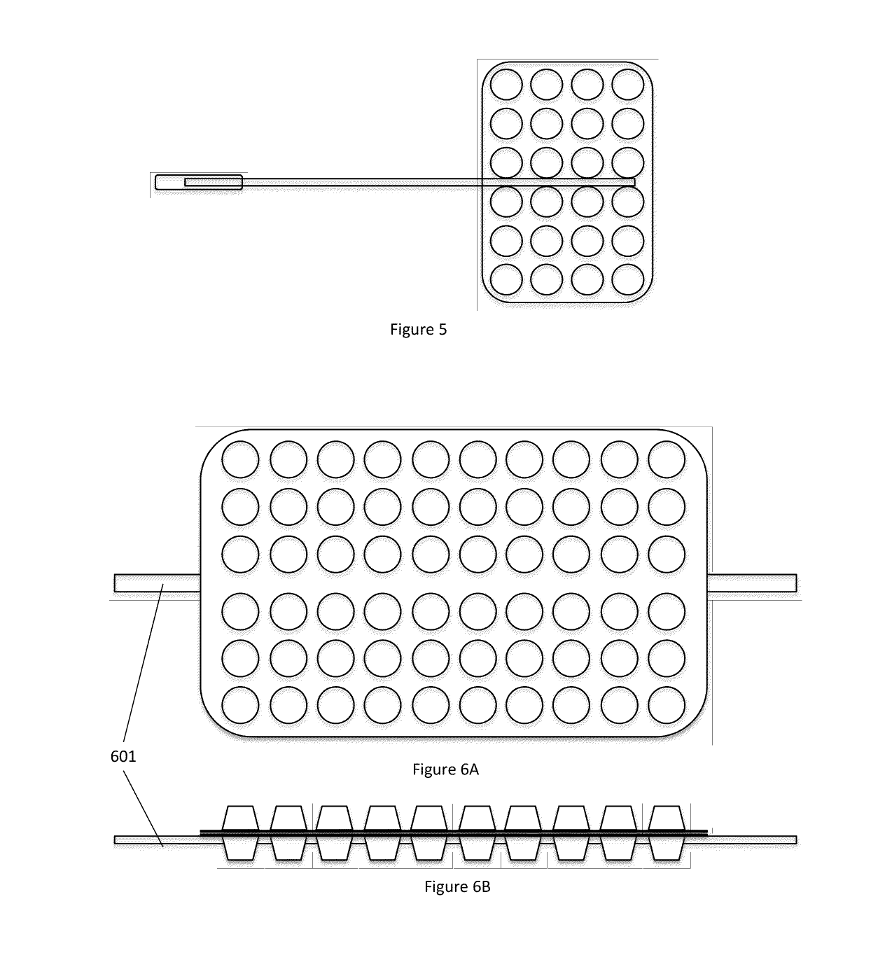

As has been stated, one of the features of some embodiments is the multiple compartments that are employed. Those skilled in the art will readily recognize, in light of and in accordance with the teachings of the present invention, that some embodiments may comprise more or fewer compartments, for example, without limitation, as few as two and up to 60 or more. A common quantity of compartments is contemplated to be ten to twelve. FIG. 5 illustrates a diagrammatic top view of an exemplary cooking device with 24 cooking compartments, in accordance with an embodiment of the present invention. FIGS. 6A and 6B illustrate an exemplary cooking device with 60 cooking compartments, in accordance with an embodiment of the present invention. FIG. 6A is a diagrammatic top view, and FIG. 6B is a diagrammatic side view. In the present embodiment the device comprises a spit type handle 601 rather than the type of handle that has been illustrated by way of example in the foregoing. Spit type handle 601 may aid in turning the entire device over and over during the cooking process.

In addition, it is contemplated that other embodiments may be further modified to include, without limitation, variations in the size and design of the compartments. The design of the compartments may be changed in order to accommodate different food types. For example, without limitation, the compartments illustrated by way of example in the foregoing embodiments are the size and shape of small muffins. Some embodiments may be built with larger food compartments that may be suitable for larger food servings. Furthermore, some embodiments may comprise compartments of various different shapes such as, but not limited to, semispherical compartments, square compartments, ornamental shapes, donut shapes, etc. Moreover, some alternate embodiments may comprise pans that have compartments of differing shapes. For example, without limitation, one such embodiment may comprise some round compartments and some square compartments. Other such embodiments may comprise one pan with one type of compartment, for example, without limitation, all muffin type compartments and another pan with another type of compartment for example without limitation semispherical compartments. Yet other alternate embodiments may comprise one pan with compartments paired with a flat piece of metal similar in perimeter size and perimeter shape to that of the bottom pan. This element acts as a flat lid with no cooking compartments to cover the bottom pan compartments so that the food being cooked does not fall out of the compartments.

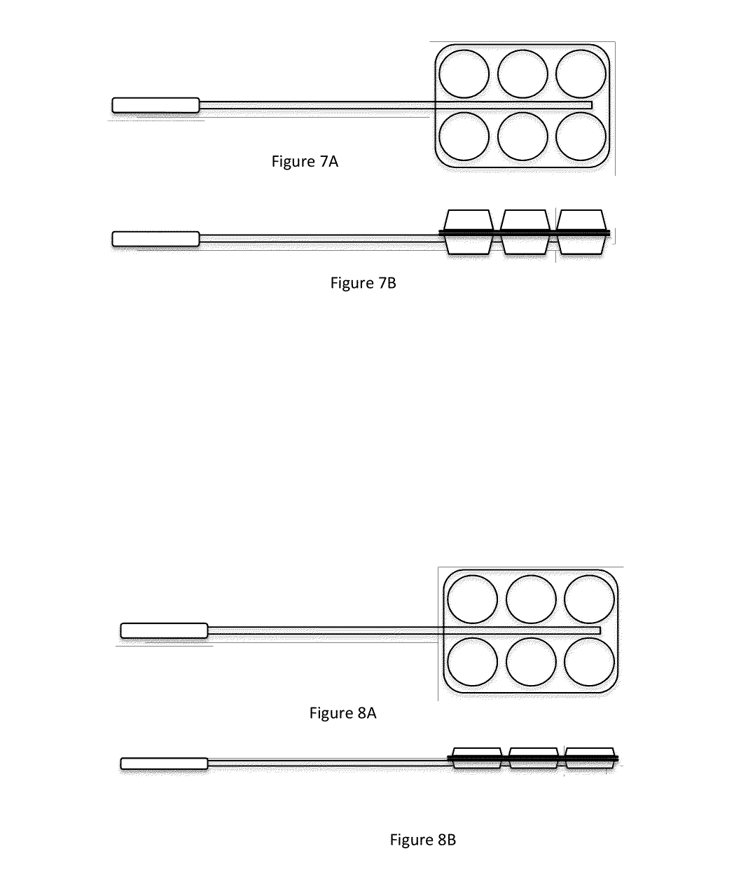

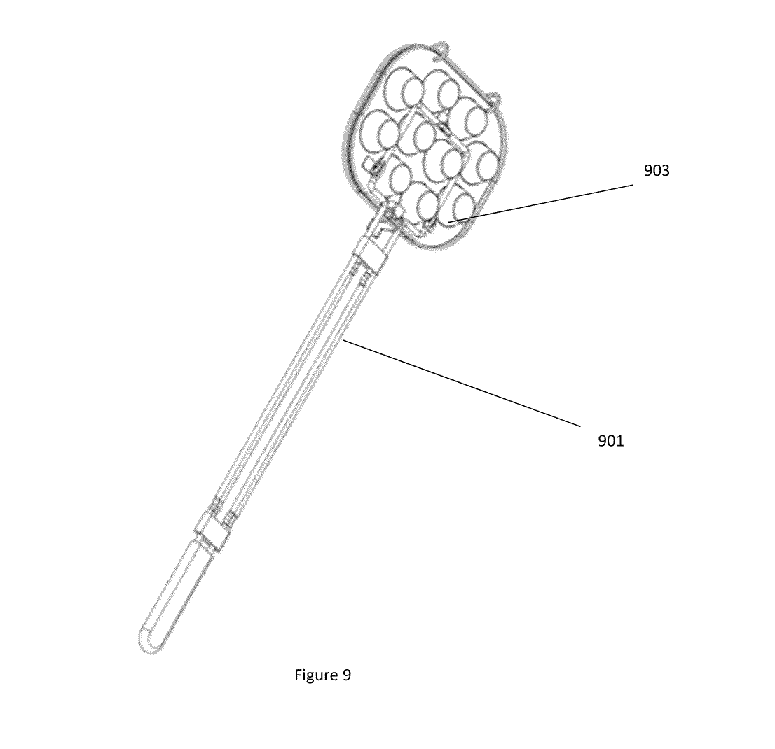

FIGS. 7A and 7B illustrate an exemplary cooking device with larger compartments, in accordance with an embodiment of the present invention. FIG. 7A is a diagrammatic top view, and FIG. 7B is a diagrammatic side view. In the present embodiment, the compartments are wider and deeper than those illustrated by way of example in the foregoing embodiments, allowing greater portion sizes to be cooked.

FIGS. 8A and 8B illustrate an exemplary cooking device with shallow compartments, in accordance with an embodiment of the present invention. FIG. 8A is a diagrammatic top view, and FIG. 8B is a diagrammatic side view. In the present embodiment, the device allows foods wider and thinner foods to be cooked for example, without limitation, when cooking cookies, pancakes, eggs, etc.

FIG. 9 is a perspective bottom view of an exemplary cooking device, in accordance with an embodiment of the present invention. In the present embodiment, the device comprises a handle 901 with two rods extending from a pan section 903. Handle 901 is extensible; however, this type of handle may be adapted to be non-extensible in some embodiments. Those skilled in the art will readily recognize, in light of and in accordance with the teachings of the present invention, that handles of various different types may be included, without limitation, in some alternate embodiments. For example, without limitation, handles in some embodiments may comprise telescoping cylindrical tubes. Other embodiments may comprise a handle portion on each pan that align and may be clamped together when the device is in the closed position. Another embodiment along this same line may comprise a longer handle on one pan and a shorter handle on the other pan that align and may be secured together when the device is in the closed position. In another alternative embodiment, a stand for resting the handle on while the pan is on a campfire may be included.

One of the many foods that can be cooked using an embodiment of the present invention is a dough-based item comprising balls of bread or biscuit dough. The dough balls can be cooked until they are like small biscuits about the size of a golf ball. The dough that is usually used is premade pop-open biscuit dough. Alternately, the dough may be made from scratch. After the dough balls are cooked, they may be finished by being rolled in melted butter and then rolled in a cinnamon and sugar mixture. To create different and more complicated foods, the dough balls can be stuffed with items such as, but not limited to, cream cheese, pepperoni, jalapenos, ham, cheese, cooked hamburger, candy, etc.

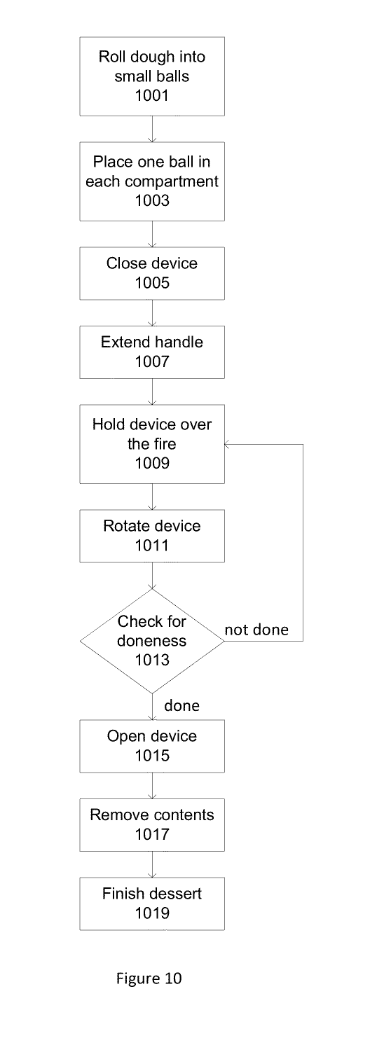

FIG. 10 is a flowchart illustrating an exemplary process for cooking a dough-based camping dessert over a campfire using a cooking device with multiple compartments, in accordance with an embodiment of the present invention. In the present example, a user first rolls the dough into separate balls about 1.25 inches in diameter or about the size of a ping pong ball in step 1001. Then in step 1003 the user places one ball of dough into each compartment of the device, or in as many compartments as desired. The user closes the cooking device and secures the closure clasp to hold the device in the closed position in step 1005. The user optionally extends the handle in step 1007, and in step 1009 holds the cooking device over the fire. In step 1011, the user rotates the device, turning the device 180 degrees every eight to ten seconds. Because the device comprises two pans to form closed compartments and a sturdy handle, the device can be rotated over and over again without the user ever touching or disturbing the food until the food is removed from the pan for eating. After three to five minutes the user removes the device from the fire in step 1013 to check to make sure that the contents are golden brown. If the dough is not cooked to the desired doneness, the user may return to step 1009 to place the device back into or over the fire for more cooking. Once the dough is cooked to the desired doneness in step 1013, the user may open the device in step 1015 and remove the contents in step 1017. The user can then finish dessert as desired in step 1019. For example, without limitation, the dough balls may be rolled in butter and then in a cinnamon and sugar mixture or the dough may be drizzled with a glaze or chocolate. When cooking over a barbeque, similar steps to those listed above may be used with the exception of step 1007, extending the handle. This step may be eliminated because the heat from a barbeque device is much more controllable and not as hot as a campfire. Therefore, the user does not need to stand so far away from the heat source.

The entire process from start to finish typically takes approximately six to eight minutes, which may be much faster than when performing the same process with current devices. Additionally, the resulting dessert is not altered with a smoky taste from the campfire or barbeque. If the recipe is changed to cook different types of food such as, but not limited to, a pepperoni, cheese, and mushroom roll or multiple recipes at once, the entire cooking process takes approximately the same amount of time. Also, this process typically produces consistently shaped and consistently cooked food product with very little variation. If the user is observant of the heat source, uses the right consistency of dough, and follows the recommended cooking process, the result will generally be golden brown properly cooked dough. Moreover, the handle of this device typically enables the user to remain far enough away from the flames or heat source while cooking so that there is reduced risk of being burned. Some embodiments may be able to be used on a conventional stove or in an oven.

It is contemplated that various different types of food such as, but not limited to, meatballs, vegetables, batter, eggs, etc. may be cooked in cooking devices according to some embodiments of the present invention. The embodiments described by way of example in the foregoing are made with fairly loose tolerances since the food that is usually cooked within the devices is a firm type of bread or roll dough and whatever additional foods the users elect to mix in with the dough, such as, but not limited to, pepperoni, cheese, cream cheese, mushrooms, etc. For cooking foods that are more liquid such as, but not limited to, pancake batter or eggs, some embodiments may be designed and built with tighter tolerances that allow pressure to release but generally do not lose or leak the contents of the food from the cooking compartments.

Those skilled in the art will readily recognize, in light of and in accordance with the teachings of the present invention, that a multiplicity of suitable additional or alternate features may be implemented in some embodiments such as, but not limited to, timers, lighters, thermometers, flashlights, heat resistant grips, vertical supports that maintain the pan section above the fire, etc. Some embodiments may be bundled with a heat source device such as, but not limited to, a camp stove or a barbeque device. Other embodiments may be implemented as a standalone device or may be bundled with other types of camping or outdoor products.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of providing a cooking device, adaptable for outdoor cooking, with multiple compartments, lid, and a longer handle according to the present invention will be apparent to those skilled in the art. The invention has been described above by way of illustration, and the specific embodiments disclosed are not intended to limit the invention to the particular forms disclosed. For example, the particular implementation of the cooking device may vary depending upon the particular type of pans used. The pans described in the foregoing were directed to rectangular implementations; however, similar techniques are to provide pans of various different shapes including, without limitation, circular shapes or triangular shapes. Non-rectangular implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A cooking device comprising:
a bottom pan comprising a plurality of bottom compartments being configured to separately contain food items during a cooking process;
a top pan being configured to cover said plurality of bottom compartments to separately retain the food items between said bottom compartments and said top pan during the cooking process;
a hinge mechanism joining said top pan to said bottom pan to enable said top pan and said bottom pan to swing apart to place and remove the food items from said compartments;
a clasp mechanism being configured to retain said top pan to said bottom pan in a closed position during the cooking process; and
a handle being joined to said bottom pan for placing said retained top pan and said bottom pan on a heat source, said handle comprising a length sufficient to enable the user to maintain a safe distance from the heat source during the cooking process, and to enable the user to flip over said retained top pan and said bottom pan in which the food items remain separated.

2. The cooking device as recited in claim 1, in which the heat source comprises a camp fire and said length is at least twice as long as is sufficient to enable the user to maintain a safe distance from a heat source comprising a cook top.

3. The cooking device as recited in claim 1, in which said top pan further comprises a plurality of top compartments matching said bottom compartments of said bottom pan in which the food items are retained between top compartments and said bottom compartments.

4. The cooking device as recited in claim 3, in which said top compartments and said bottom compartments comprise shapes resembling conical segments spaced equally distant.

5. A cooking device comprising:
a bottom pan comprising a plurality of bottom compartments being configured to separately contain food items during a cooking process;
a top pan being configured to cover said plurality of bottom compartments to separately retain the food items between said bottom compartments and said top pan during the cooking process;
a hinge mechanism joining said top pan to said bottom pan to enable said top pan and said bottom pan to swing apart to place and remove the food items from said compartments;
a clasp mechanism being configured to retain said top pan to said bottom pan in a closed position during the cooking process; and
a telescoping handle being joined to said bottom pan for placing said retained top pan and said bottom pan on a heat source, said telescoping handle enabling a user to select a desired total length of said telescoping handle to enable the user to maintain a desired distance from the heat source during the cooking process, and to enable the user to flip over said retained top pan and said bottom pan in which the food items remain separated.

6. The cooking device as recited in claim 5, in which said top pan further comprises a plurality of top compartments matching said bottom compartments of said bottom pan in which the food items are retained between top compartments and said bottom compartments.

7. The cooking device as recited in claim 5, in which said telescoping handle further comprises an outer bar and an inner bar configured to slide within said outer bar.

8. The cooking device as recited in claim 7, further comprising a locking mechanism being configured to retain said telescoping handle at the selected length.

9. The cooking device as recited in claim 8, in which said locking mechanism comprises a wire device being joined to said inner bar and being configured to engage a selected hole in said outer bar.

10. The cooking device as recited in claim 5, further comprising a grip portion disposed at a distal end of said handle.

11. The cooking device as recited in claim 5, in which said clasp mechanism comprises a tempered steel wire.

12. The cooking device as recited in claim 5, in which said hinge mechanism comprises tempered steel wires formed as a ring type device passing through holes in said top pan and said bottom pan.

13. The cooking device as recited in claim 6, in which said top compartments and said bottom compartments comprise shapes resembling conical segments.

14. The cooking device as recited in claim 13, in which said top compartments and said bottom compartments are spaced equally distant.

15. The cooking device as recited in claim 5, in which said handle comprises two rods extending from said bottom pan.

16. A cooking device comprising:
means for separately containing a plurality of food items during a cooking process;
means being configured for covering said containing means to separately retain the food items between said containing means and said covering means during the cooking process;
means being configured for joining said covering means to said containing means for enabling said covering means and said containing means to swing apart to place and remove the food items;
means being configured for retaining said covering means to said containing means in a closed position during the cooking process; and
means being joined to said containing means for placing said containing means and said covering means on a heat source, said placing means being further configured for enabling a user to select a desired total length of said placing means for enabling the user to maintain a desired distance from the heat source during the cooking process, and for enabling the user to flip over said covering means and said containing means in which the food items remain separated.

17. The cooking device as recited in claim 16, further comprising means being configured for retaining said placing means at the selected length.

18. The cooking device as recited in claim 16, further comprising means for gripping said placing means.

19. A cooking device comprising:
a bottom pan comprising a plurality of bottom compartments being configured to separately contain food items during a cooking process, said bottom compartments comprising shapes resembling conical segments and disposed equally distant;
a top pan comprising a plurality of top compartments being configured to match said bottom compartments and being configured to cover said plurality of bottom compartments to separately retain the food items between said bottom compartments and said top compartments during the cooking process;
a hinge mechanism joining said top pan to said bottom pan to enable said top pan and said bottom pan to swing apart to place and remove the food items from said compartments;
a clasp mechanism being configured to retain said top pan to said bottom pan in a closed position during the cooking process;
a telescoping handle being joined to said bottom pan for placing said retained top pan and said bottom pan on a heat source, said telescoping handle enabling a user to select a desired total length of said telescoping handle to enable the user to maintain a desired distance from the heat source during the cooking process, and to enable the user to flip over said retained top pan and said bottom pan in which the food items remain separated;
a locking mechanism being configured to retain said telescoping handle at the selected length; and
a grip portion being disposed at a distal end of said handle.

20. The cooking device as recited in claim 19, in which said telescoping handle further comprises an outer bar and an inner bar configured to slide within said outer bar.

21. The cooking device as recited in claim 20, in which said locking mechanism comprises a wire device being joined to said inner bar and being configured to engage a selected hole in said outer bar.

22. The cooking device as recited in claim 19, in which said clasp mechanism comprises a tempered steel wire.

23. The cooking device as recited in claim 19, in which said hinge mechanism comprises tempered steel wires formed as a ring type device passing through holes in said top pan and said bottom pan.

24. The cooking device as recited in claim 19, in which said handle comprises two rods extending from said bottom pan.
